(19) United States
(12) Patent Application Publication
(10) Pub. No.: US 2007/0017599 A1
(43) Pub. Date: Jan. 25, 2007

(54) Materials for making model plane components, model plane components made of such materials and the method of making thereof

(76) Inventor: Lin Lu, Zhuhai City (CN)

Correspondence Address: STARKWEATHER & ASSOCIATES, 9035 SOUTH 1300 EAST, SUITE 200, SANDY, UT, 84094, US

(21) Appl. No.: 11/261,738

(22) Filed: Oct. 28, 2005

(30) Foreign Application Priority Data
Jul. 18, 2005 (CN) 200510035959.X

(51) Int. Cl. B27C 3/00

(52) U.S. Cl. 144/93.1

(57) ABSTRACT

This invention covers a combination of materials for model plane making, model planes containing components made from the combination of the materials and the method of making thereof. The combination of materials for model plane making, includes the wood chips used for the framework, the foam used to fill in the space formed by the wood framework, and the film covering the surface formed after the foam has been filled in.

### PRIORITY CLAIM

Priority of Chinese patent application Serial No. CN200510035959.x, filed on Jul. 18, 2005, is claimed.

### BACKGROUND

1. Field of the Invention

The present invention relates generally to materials for model making, and methods of making thereof. More particularly, the present invention relates to a kind of material for model plane making, the model plane made from the material and the method of making thereof.

2. Related Art

Currently the materials for making model planes or model plane devices are mostly light wood chips and tung wood chips, which are imported from South America and are fairly expensive, which leads to the high cost of making the models. Furthermore, the models made from these light wood chips are relatively hard, and their shock resistance capacity is poor, which renders them breakable. Although the wood is a renewable resource, its vegetative cycle is relatively long, which can influence the available supply of the raw material. In view of energy conservation and environmental protection, the massive wood chopping required will lead to environmental damage. Some use light quality blow molding paper to make model planes, but its stiffness is poor, it is easily damaged and its specific weight is high, furthermore, processing the above mentioned material is relatively difficult.

### SUMMARY OF THE INVENTION

The purpose of the invention is to provide a model plane making material that is inexpensive, has a strong shock resistance ability, is of high quality and that is light in weight.

Another purpose of the invention is to offer a model plane made of the above-mentioned material.

The third purpose of the invention is to provide a method of making the model plane by using the above-mentioned materials.

The purposes of the invention are realized by the following inventive embodiments.

One embodiment of the present invention relates to materials for model plane making which includes the wood chips used to build the framework, a foam or a sponge used to fill in the spaces formed by the wood framework, and a film to cover the surface formed after the foam or sponge has been filled in.

Another embodiment of the present invention relates to a kind of model plane device made from the above mentioned material which includes the airfoil, empennage, rudder and skid fin. The above-mentioned airfoil, empennage, rudder and skid fin consist of a wood chip framework, the foam used to fill in the space formed by the wood framework, and the film used to cover the surface after the foam has been filled in.

Another embodiment of the present invention relates to a kind of method of manufacturing a model plane which comprises the following steps:
1. making the model plane or the framework of the model plane with wood chips according to a predetermined design,
2. filling in the space of the wood framework with a foam or a sponge, and
3. covering the surface formed after the framework has been filled with the foam or sponge.

Because this invention uses composite material comprising wood chips, foam and film, it greatly mitigates reliance on rare woods and reduces any influence caused by a lack of production material. Moreover, the material price is low which greatly reduces the cost of production. The material is of moderate stiffness and its shock resistance is relatively strong. According to the test, the model plane made from the above-mentioned material is better than a model plane made of light wood chips or tung chips based on air data obtained.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1 is a structure sketch map of the model plane airfoil in accordance with an embodiment of the present invention; and

FIG. 2 is a cross-sectional view of the model plane airfoil of FIG. 1 taken along line A-A in FIG. 1

Reference will now be made to the exemplary embodiments illustrated, and specific language will be used herein to describe the same. It will nevertheless be understood that no limitation of the scope of the invention is thereby intended.

### DETAILED DESCRIPTION OF EXAMPLE EMBODIMENT(S)

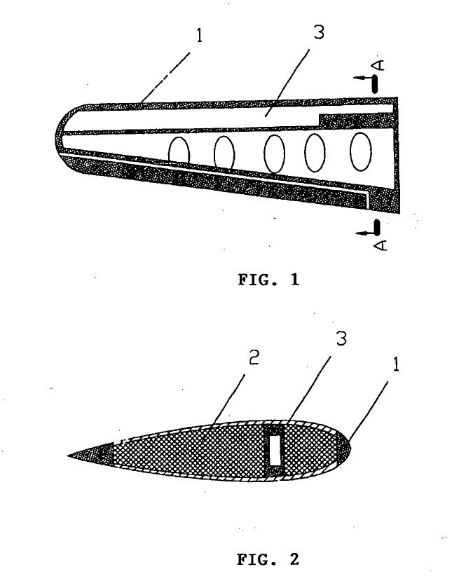

In order to better describe the technological proposal and effect of this invention, we introduce this invention by way of a model plane airfoil made from the above mentioned materials. FIGS. 1 and 2 are sketch maps of the model plane airfoil made from the above-mentioned materials. From FIGS. 1 and 2, it can be seen that the material for model plane making includes wood chips 1 forming a framework, foam 2 filling in the space of the framework and a film 3 covering the surface formed after the framework has been filled in with the foam.

The wood chip 1 is a light weight wood chip or tung chip, the foam 2 is an expanding foam, which is light weight and elastic, such as a plastics foam or sponge. The film 3 is an insulation film. In order to tightly combining the film 3, foam 2 and chip1, one side of the film is mill finished and the other side is left as a rough surface. The rough surface of the film, the foam 2 and chip1 are then stuck together with an adhesive, the milled finish of the film is oriented to the outside in order to minimize resistance. The hole sites and other parts are set up on the chip1 to connect the model plane devices.

It is well-known that the airfoil is the most important component of a model plane which is critical to model airplane performance. It is not only required to have optimal airfoil parameters, but is also required to be light weight and have a smooth surface. As shown in FIGS. 1 and 2, concerning each section along the airfoil, it is thick at first, and then tapers off. The curve becomes gradually smaller from the anterior border to the posterior border of the airfoil. The anterior border to the posterior border of the airfoil and the two sides of the airfoil are made from light wood chips, the light wood chips then form a framework structure, in this framework structure, wood hole sites and wood reinforcing bars are used to strengthen the connection between the airfoil and the other devices. The space of the framework is filled with an expanding foam 2, the film 3 is covered over the surface after the foam is filled in, one side of the film 3 is mill finished, and the other side is left rough. The rough surface of the film, the foam 2 and light quality wood framework are stuck together. Relevant parts of the airfoil will be hollowed out as necessary.

The following illustrates the light wood material, its performance and price by comparing several groups of data. Concerning its shock resistance, if the model plane drops from a height of one hundred meters, the damage caused to a model plane made from the above mentioned material is 10% while the damage to a total wood structure model plane is 80%. Concerning price, the price of a model plane made from the above mentioned material is more than 30% less than that of a model plane made from traditional materials. Concerning plasticity (or emulation), because this material adopts the filling structure, making a given shape is 30% easier than when using traditional light wood. The model plane made from the abovementioned material is better than a traditional model plan on facets such as little distortion, the comprehensive model plane parameters of flight range, and ability to fly highly difficult motions.

Except for the airfoil, the airframe, empennage (even tail and fin), rudder and skid fin are made from the above mentioned material.

From a description of the airfoil model, it is not difficult to develop a method for making model plane devices, including the following steps:
1. Making a framework of the model plane with wood chips according to a predetermined design drawing, the wood chips may be light weight wood chips or tung chips.
2. Filling the space of the wood framework in with a foam which can be an expanding foam or a plastic foam.
3. Covering the surface after the foam is filled in, in such a way that one side of the foam is mill finished and the other side is left rough. The rough surface of the film, the foam 2 and chip I are then stuck together with an adhesive. The adhesive suitable for the present invention is a member selected from the group consisting of a phenolic aldehyde adhesive, a urea-resin adhesive and a melamine formaldehyde mixed adhesive.

In addition to being used in model plane making, the above mentioned composite material of the present invention can also be used in fields where models are required to be of high quality such as being light weight and having good shock resistance, such as marine models, and which also have a low construction cost. If technical personnel in these fields use this composite material in the construction of devices which have the same function without requiring undue labor, these applications fall into the protective range of the invention rights.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

We claim:

1. A combination of materials for model plane making comprising wood chips which are used to make a framework of a model plane, a light quality elastic material which is used to fill in the space resulting from the framework, and a film which is used to cover the surface of the framework after its space is filled in.

2. The combination of materials for model plane making according to claim 1, wherein one side of the film is mill finished, the other side is a rough surface and wherein the rough surface of the film, surfaces of the light quality elastic material and the wood chips are stuck together by an adhesive.

3. The combination of materials for model plane making according to claim 1, wherein the light quality elastic material is a foam or sponge.

4. The combination of materials for model plane making according to claim 2, wherein the light quality elastic material is a foam or sponge.

5. The combination of materials for model plane making according claim 1, further comprising a predetermined number of holes and structures at predetermined positions on the wood chip to connect components of the model plane.

6. The combination of materials for model plane making according claim 2, further comprising a predetermined number of holes and structures at predetermined positions on the wood chip to connect components of the model plane.

7. A model plane comprising an airfoil, empennage, rudder and skid fin, wherein said airfoil, empennage, rudder and skid fin are made from the combination of materials for model plane making comprising a wood chip which is used to make a framework of a model plane, a light quality elastic material which is used to fill in the space resulting from the framework, and a film which is used to cover the surface of the framework after its space is filled in.

8. The model plane device according to claim 7, wherein one side of the film is mill finished, the other side is a rough surface and wherein the rough surface of the film, surfaces of the light quality elastic material and the wood chip are stuck together by an adhesive.

9. The model plane device according to claim 7, wherein the light quality elastic body is a foam or sponge.

10. The model plane device according to claim 8, wherein the light quality elastic body is a foam or sponge.

11. The model plane device according claim 7, further comprising a predetermined number of holes and structures at predetermined positions on the wood chip to connect components of the model plane.

12. The model plane device according claim 8, further comprising a predetermined number of holes and structures at predetermined positions on the wood chip to connect components of the model plane.

13. A process for making a model plane component including an airfoil, empennage, rudder and skid fin with the combination of materials for model plane making according to claim 1, comprising the steps of:
making a framework of the model plane component with a wood chip according to a predetermined design drawing; said frame work resulting in a space between the wood chips;
filling in the space of the wood framework with a light quality elastic material; and
covering the surface of the word framework with a film after it is filled in with the light quality elastic material .

14. The process according to claim 13, wherein one side of the film is mill finished, the other side is a rough surface and wherein the rough surface of the film, surfaces of the light quality elastic material and the wood chip are stuck together by an adhesive.

15. The process according to claim 14, wherein the light quality elastic material is a foam or sponge.
